(19) United States
(12) Patent Application Publication
(10) Pub. No.: US 2001/0021598 A1
(43) Pub. Date: Sep. 13, 2001

(54) Arrangement for grounding shielded cable

(76) Inventors: Osmo Miettinen, Vaasa (FI); Jukka Jaskari, Vaasa (FI)

Correspondence Address: OLIFF & BERRIDGE, PLC, 277 S. WASHINGTON STREET, SUITE 500, ALEXANDRIA, VA, 22314, US

(21) Appl. No.: 09/796,700

(22) Filed: Mar. 2, 2001

(30) Foreign Application Priority Data
Mar. 9, 2000 (FI) 20000540

(51) Int. Cl. H01R 4/66; H01R 13/648

(52) U.S. Cl. 439/98

(57) ABSTRACT

The present invention relates to a grounding arrangement, particularly in connection with a shielded cable. The arrangement comprises clamping means to connect a shield surrounding the cable to a ground potential, the clamping means being arranged to be attached to a base. The arrangement is characterized in that an elongated frame of the clamping means comprise projecting gripping means and an installation element. The base comprises a locking element for receiving the frame equipped with the gripping means and a tightening element for receiving the installation element. The frame of the clamping means is arranged in the locking element and the installation element is turned over the at least partly peeled shielded cable and attached to the tightening element by connecting means.

### FIELD OF THE INVENTION

The present invention relates to an arrangement in accordance with the preamble of claim 1 for connecting a shielded cable to a ground potential, e.g. a frame or a metal housing of a device.

### BACKGROUND OF THE INVENTION

It is previously known to carry out such groundings by attaching the shield of a peeled cable to a frame or a housing structure of a device in connection with the cable by metallic clamping means manufactured by casting or pressing. Such a grounding is, however, difficult to perform since clamping means of exactly a suitable size have to be always available. Since the diameters of cables may vary greatly, such a conventional grounding arrangement sets unnecessary requirements both for storing and selecting the clamping means at a given situation. Furthermore, the known grounding arrangements are laborious because they usually require a screw joint on both sides of the cable to be grounded for the clamping means to be attached to the ground potential.

### BRIEF DESCRIPTION OF THE INVENTION

An object of the present invention is to eliminate drawbacks of the prior art and to provide an improved grounding arrangement which is easy to use and quick to install and which can be applied to shielded cables of different sizes.

This object is achieved by an arrangement of the invention characterized by what is disclosed in the claims. To be more precise, the arrangement of the invention is mainly characterized by what is disclosed in the characterizing part of claim 1.

The idea underlying the invention is that an easily adjustable grounding arrangement ensures a reliable grounding. The arrangement of the invention thus provides, without using any connecting means, a strong bond between a base connected to a grounding potential and a first end of clamping means. The end of the clamping means is simply slipped into a locking element whereto the end is attached by gripping means in the clamping means. Such clamping means may be three-dimensional or two-dimensional, the latter being the preferred -alternative as far as the manufacturing process is concerned.

The locking element receiving the clamping means can be arranged in a frame of a device in the vicinity of the cable to be grounded or in a housing of the device. The simplest way, however, is to provide a separate base to which the clamping means can be attached and which can easily be arranged in connection with the cable to be grounded at a given time and connected to the ground potential in a manner known per se. At its simplest, the locking element is a slot or a gap passing through a given structure, or a cavity provided on one side of the structure to receive the end of the clamping means. It is also feasible to provide a surface of the base receiving the clamping means with separate means projecting from the surface for receiving both ends of the clamping means and for attaching them around the cable.

Preferred embodiments of the invention are disclosed in the attached dependent claims.

The invention provides several advantages. Such an arrangement thus enables a considerably faster grounding. The clamping means used in the grounding can be installed and detached fast, and they can be used for grounding cables of different sizes or even several cables simultaneously.

Since the grounding procedure requires only one kind of base profile and only one kind of clamping means, the arrangement of the invention thus further greatly simplifies the procedure and also substantially alleviates the storage of necessary components.

### BRIEF DESCRIPTION OF THE DRAWINGS

In the following, the invention will be described in closer detail by means of the accompanying drawings, in which

FIG. 1 is an axonometric graph showing a preferred embodiment of an arrangement for grounding a shielded cable in accordance with the invention before carrying out the grounding,

FIG. 2 is an axonometric graph showing the grounding arrangement of FIG. 1 after the grounding is completed,

FIG. 3a to f shows different preferred embodiments of clamping means, and

FIG. 4a to f shows different embodiments of a locking element.

### DETAILED DESCRIPTION OF THE INVENTION

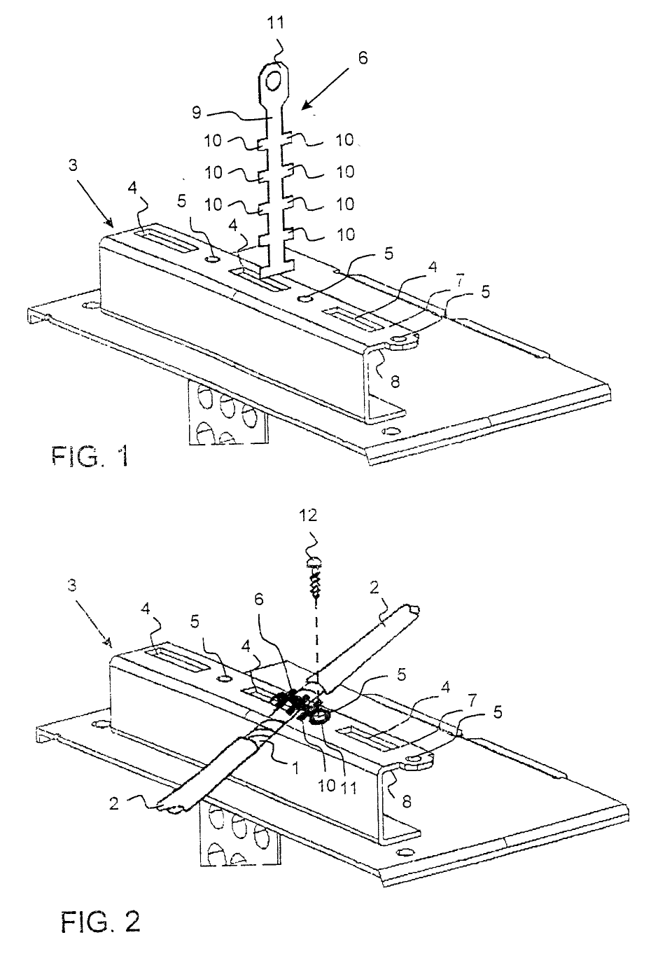

FIGS. 1 and 2 show a preferred grounding arrangement implemented using an embodiment of the invention. FIG. 2 thus shows a cable 2 equipped with a shield 1, the cable being partly peeled and arranged on a base 3 connected to a ground potential. Such a base may be a part of a frame or a housing structure of a device or, according to the figures, a completely separate piece of a profile to be attached thereto.

The base 3 receiving the cable 2 comprises receiving elements 4 and 5 whereto clamping means 6 pressing the cable against the base are to be attached. The receiving elements 4 and 5 are arranged pairwise at a distance from each other such that the peeled cable 2 can be arranged therebetween. One or more pairs of the receiving elements 4 and 5 are provided on the base 3 as necessary. One end of the clamping means 6 is thus arranged in the locking element 4 located on one side of the cable 2 arranged against the base, and the other end of the clamping means, in turn, is arranged in the tightening element 5.

The locking element 4 receiving the clamping means 6 comprises an opening, such as a slot or a gap, in the base 3, extending from its upper surface 7 to its lower surface 8, for instance according to FIG. 1 or 2. The locking element 4 may, however, also comprise a cavity of FIG. 4, arranged on one side of the base and tapering e.g. towards the cable 2 arranged on the base 3 and extending from the upper surface of the base 3 to its lower surface. The locking element 4 may also be arranged to project from the surface of the base 3 by an arched structure to be separately arranged therein. In the arrangement of the present invention, one end of the clamping means 6 is slipped into the locking element 4, the clamping means 6 then being attached to the edges of the locking element 4 located on the lower surface 8 of the base 3. When the clamping means 6 are thus attached to the locking element 4, the clamping means 6 are turned over the shield 1 revealed from the cable 2 and attached to the tightening element 5 located on the opposite side of the cable 2 in a manner known per se, using a common screw or a nut and bolt joint.

In order to enable the arrangement for grounding the shielded cable 2 to be used for attaching several cables 2 of different sizes to the ground potential, the clamping means 6 of the invention comprise an elongated frame 9 wherefrom several gripping means 10 are arranged to project mainly over the entire frame 9. Depending on the diameter of the cable 2, suitable gripping means 10 are conveyed to the locking element 4 so as to prevent the clamping means 6 from moving in the direction of the longitudinal axis thereof. One end of the clamping means 6 is preferably provided with an installation element 11 to enable the clamping means 6 to be attached to the tightening element 5 of the base 3 by e.g. separate connecting means 12. Depending on the distance of the gripping means 10 arranged in the locking element 4 from the installation element 11 located at the end of the clamping means 6, the clamping means 6 extend over the cable 2 having at a given time the smallest or the largest diameter all the way to the tightening element 5.

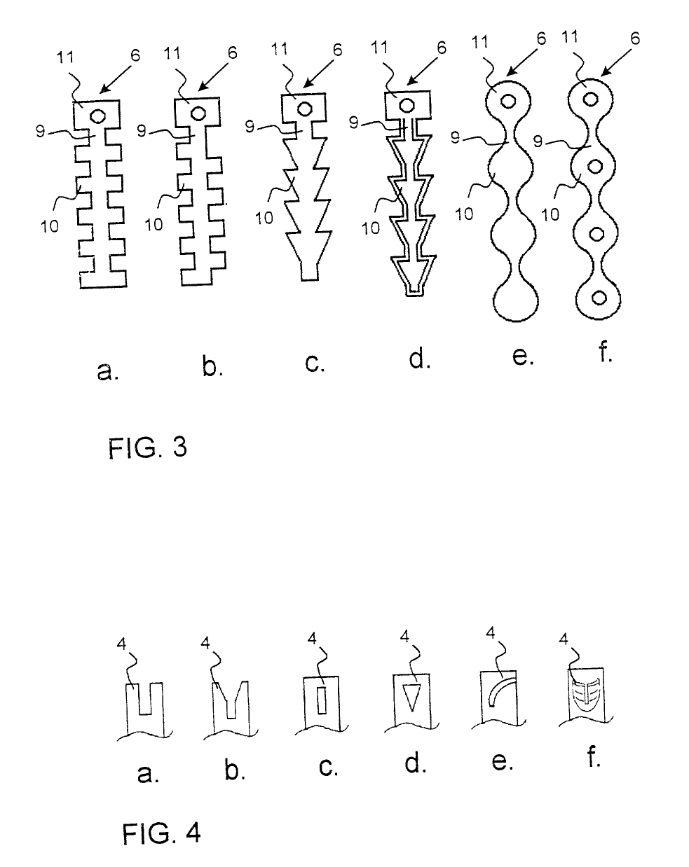

The clamping means 6 of the invention are preferably a two-dimensional plane-like piece. The gripping means 10 then comprise flanges which are substantially at a right angle with the longitudinal axis of the frame 9 and which are located on the opposite sides thereof, projecting substantially rectangularly, or wave-like or triangular ridges according to FIG. 3. The gripping means 10 are preferably arranged symmetrically on both sides of the frame 9 but if a greater adjustment possibility is to be achieved, they may also be situated unsymmetrically.

The flat clamping means 6 of the invention can be readily arranged in a locking element 4 of any shape. The locking element 4 of the invention is, however, preferably an elongated gap, or a slot, according to Figures 1 and 2, arranged substantially at a right angle with the cable 2. When the clamping means 6 are plane-like, i.e. flat, the means can simply be slipped into a gap as a common door key. When the clamping means 6 thus slipped into the gap are turned about 90° around the longitudinal axis thereof, the gripping means 10 projecting from the frame 9 are turned under the gap edges located on the lower surface of the base 3, preventing efficiently the clamping means 6 from moving in the direction of its longitudinal axis. Next, the end of the clamping means 6 equipped with the installation element 11 is attached to the tightening element 5, and the cable 2 can be pressed against the base 3. When cables 2 of different sizes are used or when several cables 2 are to be grounded simultaneously, the base 3 can be equipped with several locking elements 4 and/or several receiving elements 4 and 5.

In order to avoid arranging locking elements 4 and tightening elements 5 in each separate device frame or housing structure, it is advisable that a separate base 3 connected to the ground potential should be used. Such a base 3 may be e.g. a U-shaped profile according to the figures whose one side is attached to the housing structure or the frame of the device and whose other side is provided with several pairs of receiving elements. The base 3 can be a premanufactured piece of a predetermined size or a long pole to enable a suitable piece to be cut therefrom during use to be attached to the application.

It is to be understood that the above description and the related drawings are only intended to illustrate the present invention. The invention is thus not restricted to the embodiment disclosed above or defined in the claims only but it will be obvious to one skilled in the art that the invention can be modified and varied in many ways within the inventive idea disclosed in the attached claims.

1. A grounding arrangement, particularly in connection with a shielded cable, comprising clamping means to connect a shield surrounding the cable to a ground potential, characterized in that the clamping means in the arrangement are attached to a base connected to the ground potential, the clamping means comprising an elongated frame and gripping means projecting from the frame, and substantially one end of the frame being provided with an installation element receiving connecting means, and in that the base comprises receiving elements, i.e. at least one locking element, extending from its upper surface to its lower surface for receiving the frame equipped with the gripping means, and at least one tightening element for receiving the installation element when the end of the clamping means equipped with the gripping means is arranged in the locking element and when the installation element at the opposite end of the clamping means is turned over the at least partly peeled shielded cable arranged on the base and attached to the tightening element by the connecting means, the clamping means arranged in the base thus being arranged, together with the base, to surround the shielded cable and press the cable against the base.

2. An arrangement as claimed in claim 1, characterized in that the locking element comprises a slot positioned substantially rectangularly with respect to the cable in the arrangement arranged between the clamping means and the base.

3. An arrangement as claimed in claim 1, characterized in that the locking element comprises a cavity positioned substantially rectangularly with respect to the cable in the arrangement arranged between the clamping means and the base.

4. An arrangement as claimed in any one of claims 1 to 3, characterized in that the clamping means are mainly flat and substantially two-dimensional, whereby the locking element receiving the clamping means is an elongated slot enabling the clamping means to be slipped therethrough and turned about 90° around the longitudinal axis thereof such that at least one gripping means in the clamping means cooperates with the edge at the lower surface of the base to prevent the clamping means from being removed from the slot.

5. An arrangement as claimed in any one of the preceding claims, characterized in that the base comprises a substantially U-shaped piece to receive the cable and to be connected to a housing structure, one side of the piece being attached to the housing structure and the side of the piece opposite to the housing structure being provided with at least one pair of the receiving elements.

6. An arrangement as claimed in any one of the preceding claims, characterized in that the gripping means comprise rectangular flanges substantially rectangularly projecting from the frame and located on the opposite sides of the elongated frame.

7. An arrangement as claimed in any one of the preceding claims, characterized in that the gripping means comprise wave-like ridges located on the opposite sides of the elongated frame.

8. An arrangement as claimed in any one of the preceding claims, characterized in that the gripping means comprise triangular flanges on the opposite sides of the elongated frame.

9. An arrangement as claimed in any one of the preceding claims, characterized in that the gripping means are arranged symmetrically on both sides of the frame.
